(19) United States
(12) Patent Application Publication
(10) Pub. No.: US 2022/0376913 A1
(43) Pub. Date: Nov. 24, 2022

(54) Concurrent Token Authentication

(71) Applicant: Thomas Eric Boldt, Watertown, TN (US)

(72) Inventor: Thomas Eric Boldt, Watertown, TN (US)

(21) Appl. No.: 17/325,180

(22) Filed: May 19, 2021

(51) Int. Cl. H04L 9/32

(52) U.S. Cl. CPC H04L 9/3213

(57) ABSTRACT

The concurrent token authentication method, operating within a cryptographically secured context, enables a service account to be authenticated continuously by means of a set of three distinct tokens: primary, secondary, and reserved. A token is an immutable secret key. Through a lifecycle, a token is registered manually or programmatically to become the reserved token, thereafter upon first authentication said token is promoted from reserved to primary, and thereafter upon a subsequent new token registration and first authentication event, the original said token is promoted from primary to secondary. Thereafter upon another new token registration and first authentication event, the original said token is terminated. The concurrent token authentication lifecycle provides for token set expiration. Expiration is advanced following first authentication of a reserved token. Upon reaching expiration token set is terminated.

### CROSS-REFERENCE TO RELATED APPLICATIONS

Related to Provisional Utility Patent Application 63/093,183

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Program code to be included: proof of concept implementation written in the Java programming language

### STATEMENT REGARDING PRIOR DISCLOSURES BY THE INVENTOR OR JOINT INVENTOR

Not Applicable

### (g) BACKGROUND OF THE INVENTION

The invention relates to computer software authentication by cryptographically secured secret tokens and the token renewal process. It resolves problems relating to service interruption, coordination of resources, performance, and potential for human error.

### BRIEF SUMMARY OF THE INVENTION

Secret token-based authentication is commonly used in systems and applications service accounts. Generally a single secret token or password is valid for a specified duration. Routine service account secret token changes are often done on a routine basis. Difficulties and delays may be encountered during these routine token changes such as:
1. When applications require uninterrupted access to a token authenticated service.
2. When scheduling the resources, persons, and application maintenance in preparation for secret token changes.
3. When a manual secret token change process consumes an indeterminate amount of time.
4. When a manual secret token change process is subject to human error.
5. When a manual secret token change process poses a risk of compromising tokens.

Therefore, concurrent token authentication solution seeks to address these concerns by providing continuous authentication capability and automated token renewals to eliminate down time, human error, and challenges involved with coordinating people, resources and applications to convene a synchronous manual process. Security is improved by reducing risk of compromised tokens. With automation and increasing frequencies of token renewals the risk associated with compromised tokens is further reduced in proportion to the reduction of the duration of time during which a potential attacker may exploit compromised tokens.

### BRIEF DESCRIPTION OF THE DRAWING(S)

FIG. 1 is the embodiment of token change lifecycle events and states.

### DETAILED DESCRIPTION OF THE INVENTION

### 1. Definition of Terms

Token—A secret key which is a unique, immutable value. It may represent any number, human readable password, computer generated random string, hash, or any value which may be represented as a string. The essential characteristics of a token are immutability, secrecy, and uniqueness with respect to other current tokens for an account. Additional non-essential characteristics of tokens are long length, randomly generated content, and long life cycle.

Registration—the creation of a new reserved token. The registration request may be initiated manually, or it may be initiated programmatically by the client. The client supplies the token.

Token Minimum Lifespan Interval—the minimum interval of time required between the first authentication of the previous reserved token and the registration of the next reserved token for an account. The reserved token is null during this interval.

Token Maximum Lifespan Interval—the interval of time by which token set expiration is advanced following first authentication of a reserved token.

Token Initial Lifespan Interval—the interval of time by which reserved token expiration is advanced relative to the moment the token is registered.

Reserved Token—a newly registered token that has not yet been used for client authentication. Following first authentication a reserved token is promoted to primary token.

Primary Token—a previously reserved token currently accepted for authentication by the server.

Secondary Token—a previously primary token currently accepted for authentication by the server.

Account—the server resource identified by a user ID and authenticated with a token.

Client—the client which authenticates with the server. This may be a browser, application, or other computing device.

Server—the host or service to which the client presents the token for authentication, this may be a computer system, database server, directory service, or any resource requiring authentication.

Expiration—that moment the set of tokens for an account expires.

First Authentication—the moment a reserved token is initially authenticated by the server as a result of an authentication request by the client.

Termination—the token ceases to exist.

Super User—a user with administrative credentials privileged to perform advanced operations on accounts such as create, delete, expire, unlock, and lock.

### 2. Token Lifecycle

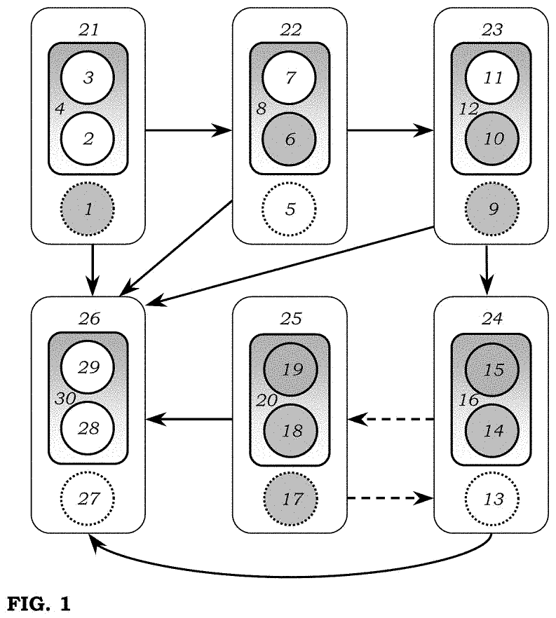

All references are made to FIG. 1, wherein large rounded rectangles are states, circles are tokens, small shaded rounded rectangles are the concurrent tokens, solid line arrows are state changes, and dashed line arrows are state changes within a repeatable normal operation cycle.
a. State 21 after a new account is created or unlocked with a reserved token:
   1—reserved token (not null).
   2—primary token (null).
   3—secondary token (null).
   4—concurrent tokens (null).
b. State 22 after first authentication of the reserved token:
   5—reserved token (null).
   6—primary token (not null; formerly token 1 in state 21).
   7—secondary token (null).
   8—concurrent tokens (primary available).
c. State 23 after registering new reserved token:
   9—reserved token (not null).
   10—primary token (not null; formerly token 6 in state 22).
   11—secondary token (null).
   12—concurrent tokens (primary available).
d. State 24 after first authentication of reserved token:
   13—reserved token (null).
   14—primary token (not null; formerly token 9 in state 23).
   15—secondary token (not null; formerly token 10 in state 23).
   16—concurrent tokens (primary and secondary available).
e. State 25 after registering new reserved token:
   17—reserved token (not null).
   18—primary token (not null; formerly token 14 in state 24).
   19—secondary token (not null; formerly token 15 in state 24).
   20—concurrent tokens (primary and secondary available).
f. In normal operation state cycles between state 24 and 25.
g. State 27 after expiration or lock:
   27—reserved token (null).
   28—primary token (null).
   29—secondary token (null).
   30—concurrent tokens (null).

### 3. Token Set Expiration Methods

a. The expiration of a set of tokens is triggered by events:
   1. The passage of time past the expire date.
   2. The account is locked by the super user.
   3. The account is explicitly expired by the account user.
b. The expiration datetime is set or advanced by events:
   1. When an account is created, expiration is set to the current datetime plus the token initial lifespan interval.
   2. When a new reserved token is registered, expiration is set to the current datetime plus the token maximum lifespan interval.
   3. When a lock account is unlocked, expiration is set to the current datetime plus the token initial lifespan interval.
   4. When an account is expired by the account user, expiration and all tokens are set to null.
   5. When a reserved token is first authenticated, expiration is set to the current datetime plus the token maximum lifespan interval.

### 4. Token Change Methods and Process

a. A client changes the token in two steps:
   1. A new reserved token is registered.
   2. The reserved token is initially authenticated.
b. A token change promotes existing tokens:
   1. Primary token is promoted to secondary.
   2. Reserved token is promoted to primary.
c. A client assimilates an asynchronous token change:
   1. Asynchronous token change condition is indicated when authenication by secondary token fails.
   2. Client uses old primary token to get new primary token.
   3. Client then has both primary and secondary tokens.
d. An account is locked:
   1. All tokens are set to null.
e. An account is unlocked:
   1. The reserved token is initialized.
f. An account is created:
   1. The reserved token is initialized.
g. An account is deleted.

The invention claimed is:

1. A method for the desynchronization and automation of a token renewal process with said method including an expiration, and a set of three unique, immutable, secret tokens: two interchangeable tokens designated primary and secondary, and a reserved token, wherein also the primary and secondary tokens are accepted interchangeably by the server for authentication, wherein also the secondary token is accepted for authentication until the reserved token is initially authenticated, thereafter, the secondary token is terminated, the primary token is promoted to secondary, the reserved token is promoted to primary, and the expiration is advanced by the token maximum lifespan interval, and additionally the set of all said tokens have a collective expiration, which is the moment at which said set of tokens are terminated; accordingly a life cycle of continuous authentication is established when a new unique secret token is registered as reserved by the server when requested by the client and authenticated with an acceptable primary or secondary token.

2. The method according to claim 1, further comprising: a method wherein the client authenticates its token with the set of server tokens, whereby said token that is submitted with the client authentication request is evaluated for a match with any of primary, secondary, and reserved tokens.

3. The method according to claim 1, further comprising: a method wherein the interval of time by which the expiration is advanced upon first authentication of an existing account is determined by the token maximum lifespan interval.

4. The method according to claim 1, further comprising: a method wherein the interval of time between first authentication of a reserved token and next token registration during which token reservation is disallowed is specified by the token minimum lifespan interval.
